(19) United States
(12) Patent Application Publication
(10) Pub. No.: US 2008/0254358 A1
(43) Pub. Date: Oct. 16, 2008

(54) RECHARGEABLE LITHIUM BATTERY

(75) Inventors: Hironari Takase, Yokohama-shi (JP); Sung-Soo Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd.

(21) Appl. No.: 11/865,119

(22) Filed: Oct. 1, 2007

(30) Foreign Application Priority Data
Oct. 2, 2006 (JP) 2006-270424
Oct. 1, 2007 (KR) 10-2007-0098681

(51) Int. Cl. H01R 33/02; H01R 3/00; H01R 29/00

(52) U.S. Cl. 429/163; 429/209; 429/188

(57) ABSTRACT

The rechargeable lithium battery according to one embodiment includes a negative electrode, a positive electrode, and an electrolyte in a case. The rechargeable lithium battery includes a compound that forms a coordinate covalent bond with anions in at least one of a negative electrode, a positive electrode, an electrolyte, and an inner surface of a case. The rechargeable lithium battery can inhibit electrode corrosion at a high voltage and can be manufactured without requiring additional fabrication processes.

### CROSS-REFERENCE TO RELATED APPLICATIONS

This application claims the benefits of Japanese Application No. 2006-270424, filed Oct. 2, 2006, in the Japanese Intellectual Property Office, and Korean Application No. 2007-98681 filed Oct. 1, 2007, in the Korean Intellectual Property Office, the disclosures of which are incorporated herein by reference.

### BACKGROUND OF THE INVENTION

1. Field of the Invention

Aspects of the present invention relate to a rechargeable lithium battery. More particularly, aspects of the present invention relate to a rechargeable lithium battery to inhibit electrode corrosion at a high voltage and that can be manufactured without requiring an increase in the number of fabrication processes.

2. Description of the Related Art

A rechargeable lithium battery includes a positive electrode and a negative electrode that intercalates and deintercalates lithium ions, in a non-aqueous electrolyte. The positive electrode includes a positive active material such as LiCoO₂, and the negative electrode includes a negative active material such as carbon black. For the electrolyte, a solute such as LiPF₆ dissolved in a solvent such as ethylene carbonate is used.

Rechargeable batteries are widely used for portable electronic devices, such as personal computers, mobile phones, and the like. Since these electronic devices are intended to be operated for a long term from a full charge despite a huge consumption of electric power, the rechargeable batteries are required to have high capacity. Recently, research on developing a rechargeable lithium battery with a high capacity by increasing the charge potential has been widely undertaken.

However, when a rechargeable lithium battery has a high-capacity as a result of increasing the charge potential, the positive electrode therein acts as an oxidant, and the electrolyte is easily oxidized. The decomposed electrolyte may cause deposits to accumulate on the surface of the positive electrode, which resultantly makes it difficult for the battery to maintain a high voltage for a long term.

The electrolyte of a lithium battery includes a lithium salt such as LiPF₆ or the like. Typically, a lithium salt such as LiPF₆ is produced in a reaction process using a chloride-containing reactant such as PCl₅ or the like. As a result, anions such as Cl ions and the like may remain as contaminants in the electrolyte. The anion contaminant in the electrode may react with an active material such as Co or the like included in the electrode, and the combined product including Co may be easily eluted. Thereafter, the eluted Co may corrode the electrode, causing the capacity of the rechargeable lithium battery to deteriorate or the eluted Co may reach the counter electrode, causing a short-circuit. In particular, since an active material has decreased stability under a high voltage and is easily eluted, capacity of a battery containing an active material under a high voltage may deteriorate, and short-circuits may occur more frequently. As a result, there are disadvantages to providing a conventional lithium salt-containing rechargeable battery with a high capacity.

Japanese Patent laid-open No. 2003-338321 (hereinafter, “JP '321) describes a method of maintaining a high voltage for a long term in a rechargeable lithium battery by disposing an inorganic solid electrolyte layer on the surface of a positive electrode in the rechargeable lithium battery to prevent oxidation of an electrolyte (see, for example, p. 2-7, FIG. 1 of JP '321). As described in JP '321, an inorganic solid electrolyte layer disposed on the surface of an electrode can suppress the corrosion of the electrode due to anions. However, the disposition of the inorganic solid electrolyte layer on the surface of the positive electrode necessitates an increased number of fabrication processes. In addition, since the inorganic solid electrolyte layer includes an alkali metal or the like, which is combined with anions and then eluted, the inorganic solid electrolyte layer deteriorates. As a result, the electrode cannot be completely prevented from corrosion over the long term.

### SUMMARY OF THE INVENTION

Aspects of the present invention provide a rechargeable lithium battery in which electrode corrosion at a high voltage is inhibited and that can be manufactured requiring an increase in the number of fabrication processes.

According to an embodiment of the present invention, there is provided is a rechargeable lithium battery that includes a negative electrode, a positive electrode, an electrolyte and a case enclosing the negative electrode, the positive electrode and the electrolyte. The rechargeable lithium battery includes a compound that forms a coordinate covalent bond with anions in at least one of the negative electrode, the positive electrode, the electrolyte, and an inner surface of the case.

According to an aspect of the present invention, the positive active material may include LiCoO₂. In addition, the positive active material may additionally include a conductive material and P₂O₅ as the compound that forms a coordinate covalent bond with anions, forming a positive active mass. The P₂O₅ coordinately bonds with anionic contaminants including halogen ions such as F ions and Cl ions in an electrolyte, and thereby forms a complex. The coordinate bonding of the compound with the anions proceeds faster than ionic bonding of a transition metal with the anions. The compound that forms a coordinate covalent bond with anions can thereby prevent Co in the positive active material from being combined with anions. Accordingly, the compound that forms a coordinate covalent bond with an anion such as P₂O₅ and the like may be included in a rechargeable lithium battery.

According to an aspect of the present invention, the compound that forms a coordinate covalent bond with anions may be included in the negative electrode, the positive electrode, or the electrolyte of the rechargeable lithium battery. In addition, the compound may be coated inside the case.

According to an aspect of the present invention, the compound may include an element selected from the group consisting of 3B, 4B, 5A, and 5B groups, and combinations thereof. Herein, the 3B, 4B, 5A, and 5B groups respectively match groups 5, 13, 14, and 15 in the IUPAC periodic table.

According to an aspect of the present invention, the compound may be selected from the group consisting of a phosphor oxide, a boron oxide, and mixtures thereof.

According to an aspect of the present invention, the compound may be P₂O₅ or B₂O₃.

According to an aspect of the present invention, at least either of the positive electrode or the negative electrode may include a transition element.

According to an aspect of the present invention, the electrolyte may include halogen ions. According to an embodiment of the present invention, there is provided a negative electrode of a rechargeable lithium battery comprising a negative active material; a conductive material; a binder; and a compound that forms a coordinate covalent bond with anions.

According to an embodiment of the present invention, there is provided a positive electrode of a rechargeable lithium battery comprising a positive active material; a conductive material; a binder; and a compound that forms a coordinate covalent bond with anions.

According to an embodiment of the present invention, there is provided an electrolyte of a rechargeable lithium battery, comprising a lithium salt containing halogen ion impurities; a solvent; and a compound that forms a coordinate covalent bond with anions.

According to an embodiment of the present invention, there is provided a case of a rechargeable lithium battery having an inner surface, wherein the inner surface of the case includes a coating comprising a compound that forms a coordinate covalent bond with anions.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a vertical cross-sectional view of a rechargeable lithium battery according to an embodiment of the present invention;

FIG. 2 shows reactions between additives of a positive electrode and anions in a rechargeable lithium battery according to an embodiment of the present invention; and

FIG. 3 shows a relationship of charge potential and charge time of the rechargeable lithium battery cells including positive electrodes according to Examples 1 and 2, and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

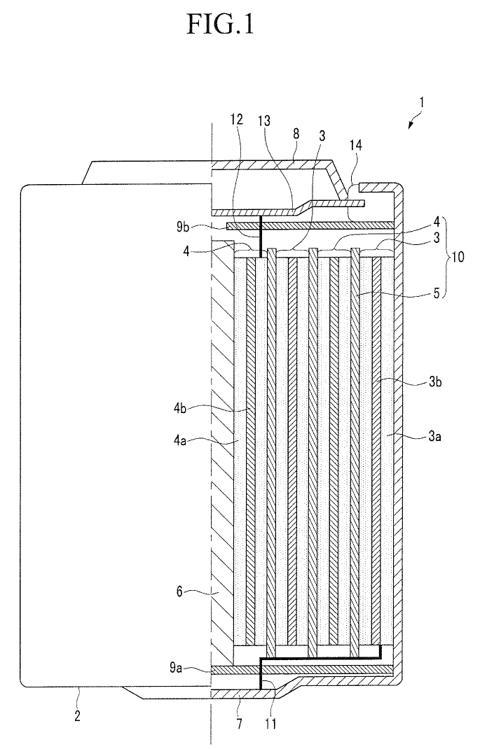

FIG. 1 is a vertical cross-sectional view of a rechargeable lithium battery according to an embodiment of the present invention. The rechargeable lithium battery 1 is a spirally wound cylindrical battery that includes a center pin 6 and an electrode assembly 10 wound around the center pin 6. The electrode assembly 10 includes a positive electrode 3 and a negative electrode 4, and a separator 5 inserted therebetween. Accordingly, the electrode assembly 10 has a cylindrical structure.

The positive electrode 3 is formed by disposing a positive active mass 3a including a positive active material on both surfaces of a positive current collector 3b. The negative electrode 4 is formed by disposing a negative active mass 4a including a negative active material on both surfaces of a negative current collector 4b. The cylindrical electrode assembly 10 is housed in a cylindrical case 2 with a hollow space and impregnated with an electrolyte (not shown). The positive electrode 3 contacts the case 2, and has a positive terminal 7 that protrudes at the bottom thereof.

The electrode assembly 10 is mounted with insulating plates 9b and 9a at the top and bottom thereof. The positive current collector 3b passes through the insulating plate 9a and contacts with the positive terminal 7 by way of a positive electrode lead 11. A safety plate 13 is mounted above the insulating plate 9b located at the opening of the case 2 in the same direction as the insulating plate 9b. A negative terminal 8 shaped as a convex cap is mounted on the safety plate 13 in the opposite direction to the safety plate 13. The negative current collector 4b passes through the insulating plate 9b and contacts the negative terminal 8 by way of a negative electrode lead 12. In addition, the safety plate 13 and the edge of the negative terminal 8 are sealed by a gasket 14, which separates them from a positive terminal 7. It is to be understood that other structures for the rechargeable lithium battery 1 and the electrode assembly 10 may be used.

The positive active mass 3a is prepared by mixing a positive active material, a conductive material, and an additive with a binder, and then coating the mixture on the positive current collector 3b. The positive active material may include a lithium transition element oxide such as LiCoO₂ and the like. The conductive material may include acetylene black and the like. The binder may include polyvinylidene fluoride and the like.

The additive may include a compound that forms a coordinate covalent bond with anions such as, for example, a compound selected from the group consisting of 3B, 4B, 5A, and 5B groups or combinations thereof. Among these materials, phosphor oxides and boron oxides are relatively cheaper, and P₂O₅ and B₂O₃ are easy to obtain commercially.

The negative active mass 4a may include a negative active material comprising a carbon material and a binder and is coated on the negative current collector 4b.

The electrolyte may include a solute including a lithium salt such as, for example, LiPF₆, Li₂SiF₆, Li₂TiF₆, LiBF₄, or the like, in a solvent such as, for example, ethylene carbonate, diethyl carbonate, or the like. As discussed above, LiPF₆ or the like, included in the electrolyte are typically produced by a reaction process using a chloride-containing reactant such as, for example, PCl₅ or the like. Accordingly, anions such as halogen ions (Cl ions) or the like may remain as acid contaminants in the electrolyte. Further, anions can be eluted from impurities or oil attached to an electrode or the case 2 while manufacturing the rechargeable lithium battery 1, and can then remain as acid impurities in the electrolyte.

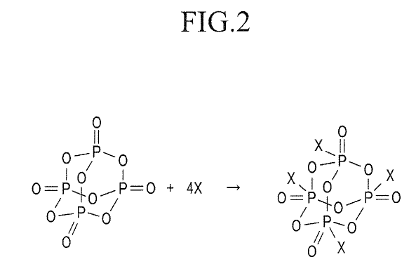

Since the positive electrode 3 includes an additive comprising a compound that coordinates anions, the compound coordinately combines with acid impurities such as halogen ions (Cl ions, F ions, or the like) or the like in the electrolyte. In other words, as shown in FIG. 2, when P₂O₅ is used as an additive, P₄O₁₀ including P₂O₅ coordinately combines with an anion X, forming a complex.

The positive active material also includes transition elements such as Co or the like that can easily combine with anions. However, the coordinate bonding of the compound coordinates anions tends to proceed faster than an ionic bonding of transition elements, such that transition elements are prevented from combining with anions. As a result, the positive active material containing transition elements can be prevented from eluting and the positive electrode 3 can be prevented from corroding under a high voltage in which transition elements become unstable, Thereby, a high-capacity of the rechargeable lithium battery 1 can be achieved.

In addition, since the complex formed by coordinating anions has a strong bond, an element of 3B, 4B, 5A, or 5B groups such as P or B does not depart therefrom. Accordingly, since the element is eluted from a complex, there is no problem of precipitation or the like. Furthermore, the positive electrode 3 that includes the protective additive can be fabricated by only adding the additive without increasing the number of fabrication processes.

In other words, the positive electrode 3 includes an additive including an alkali, such that the alkali can be combined with anions in an electrolyte and neutralized. As a result, the additive can suppress the combination of transition elements of the positive electrode 3 and anions. However, if a compound that does not coordinate anions is used, water is produced in the non-aqueous electrolyte and simultaneously, the alkali is re-eluted and precipitated at the counter electrode, resulting in a deteriorated performance of the rechargeable lithium battery 1. Accordingly, when a compound that is coordinates anions as is included an additive, the deterioration of battery performance caused by the production of water and re-elution and precipitation can be prevented.

According to the embodiment of the present invention, the positive electrode 3 includes transition elements and an additive. However, when the negative electrode 4 includes transition elements, it can also include an additive compound that coordinates anions. In addition, an additive compound that coordinates anions can not only be included in an electrode, but can also be included in the electrolyte or the separator 5. The additive compound can also be coated inside the case 2.

The following examples illustrate aspects of the present invention in more detail. However, it is understood that the present invention is not limited by these examples.

### Example 1

A positive active mass of a positive electrode for a rechargeable lithium battery cell was prepared by mixing LiCoO₂ as a positive active material, acetylene black as a conductive material, P₂O₅ as an additive, and polyvinylidene fluoride as a binder. In particular, 95 parts by weight of LiCoO₂, 2 parts by weight of acetylene black, 0.5 parts by weight of P₂O₅, and 2.5 parts by weight of polyvinylidene fluoride were mixed, and then an N-methyl-2-pyrrolidone solution was added thereto, preparing a paste. The paste was uniformly coated on a 20 μm-thick Al foil as a positive current collector and then dried, providing a positive electrode.

### Example 2

A positive active mass of a positive electrode was prepared by mixing LiCoO₂ as a positive active material, acetylene black as a conductive material, B₂O₃ as an additive, and polyvinylidene fluoride as a binder. In particular, 95 parts by weight of LiCoO₂, 2 parts by weight of acetylene black, 1 part by weight of B₂O₃, and 2 parts by weight of polyvinylidene fluoride were mixed, and then an N-methyl-2-pyrrolidone solution was added thereto to prepare a paste. The paste was uniformly coated on a 20 μm-thick Al foil as a positive current collector and then dried, gaining a positive electrode.

### Comparative Example 1

A positive electrode was prepared according to the same method as in Example 1, except that P₂O₅ as an additive was not included.

When the positive electrodes according to Example 1 and Comparative Example 1 were immersed in an electrolyte, the elution of Co in the positive active material by acid impurities in the electrolyte was examined.

The experiment of determining Co elution by acid impurities in the electrolyte was performed by respectively immersing the positive electrodes 3 of Example 1 and Comparative Example 1 in an electrolyte prepared by adding 909 ppm of F ions and 5 ppm of Cl ions (Experiment 1) and another electrolyte prepared by adding 25 ppm of F ions and 600 ppm of Cl ions (Experiment 2), and then allowing the immersed electrodes to stand at 60° C. for 48 hours. Then, the color of the electrolytes was observed visually.

Based on the experiment results, the positive electrode of Comparative Example 1 not including P₂O₅ as an additive not only had Co eluted in both of the electrolytes of Experiments 1 and 2, but the electrolyte containing the eluted Co was also found to be colored. By contrast, neither of the electrolytes of Experiments 1 and 2 changed color in the positive electrode of Example 1, showing that Co was prevented from elution.

Next, rechargeable battery cells including positive electrodes according to Examples 1 and 2 and Comparative Example 1 were fabricated and examined regarding voltage change after charge.

The positive electrodes of Examples 1 and 2 and Comparative Example 1 were respectively included in the rechargeable lithium battery cells. A negative active mass of the negative electrode was prepared by mixing a carbon material powder as a negative active material and polyvinylidene fluoride as a binder. In particular, 90 parts by weight of the carbon material powder was mixed with 10 parts by weight of polyvinylidene fluoride, and an N-methyl-2-pyrrolidone solution was added thereto, preparing a paste. The paste was uniformly coated to be 20 μm-thick on a Cu foil as a negative current collector, preparing a negative electrode.

A 20 μm-thick polypropylene separator was disposed between the positive electrode and the negative electrode.

An electrolyte was prepared by adding LiPF₆ to ethylene carbonate and then adding 50 ppm of Cl ions to the electrolyte solution. Herein, the 50 ppm of Cl ions was included in the electrolyte solution as a comparison experiment. Accordingly, more Cl were included than would be contained in a typical rechargeable lithium battery.

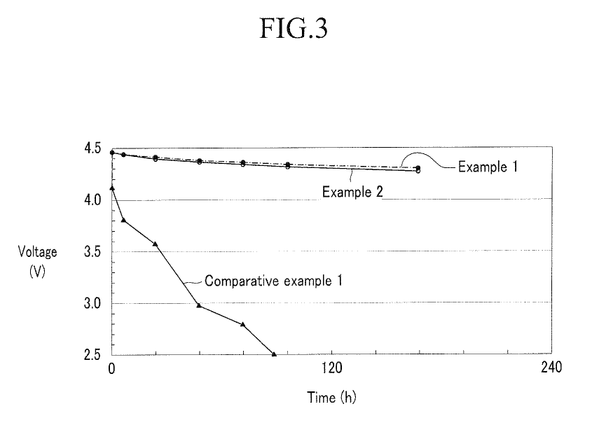

Each of the rechargeable lithium batteries fabricated in the aforementioned method were allowed to stand at 45° C. for 1 hour and then were charged at 0.1 A of a constant current up to 4.5V. Then, the charged lithium batteries were allowed to stand at a high temperature of 80° C., and their voltages were measured. The results are shown in FIG. 3.

Referring to FIG. 3, the vertical axis indicates a voltage (unit: V), while the horizontal axis indicates elapsed time (unit: hour).

As shown in FIG. 3, the rechargeable lithium battery cells including the positive electrodes of Examples 1 and 2 had somewhat deteriorated voltages after 160 hours, while the rechargeable lithium battery cell including the positive electrode of Comparative Example 1 had a sharply deteriorated voltage after a lesser amount of time. Based on the results, the positive electrodes of Examples 1 and 2 can be said to have better anti-corrosion effects than that of Comparative Example 1.

In addition, the rechargeable lithium battery cells including the positive electrodes of Examples 1 and 2 and Comparative Example 1 were discharged and then measured regarding retention capacity. Then, they were repeatedly charged and discharged again and examined regarding recovery capacity. The results are shown in the following Table 1.

Each value in Table 1 was determined considering cell capacity, when charged and discharged before being stored at 80° C., as 100%.

TABLE 1

| | Comparative | | |
|---|---|---|---|
| | Example 1 | Example 1 | Example 2 |
| Capacity before storage (%) | 100 | 100 | 100 |
| Retention capacity (%) | 0 | 83 | 83 |
| Recovery capacity (%) | 10 | 98 | 97 |

As shown in Table 1, the rechargeable lithium battery cell including the positive electrode of Comparative Example 1 had a retention capacity 0% and a recovery capacity of 10%. By contrast, the rechargeable lithium battery cell including the positive electrode of Example 1 had a retention capacity of 83% and a recovery capacity of 98%. The rechargeable lithium battery cell including the positive electrode of Example 2 had a retention capacity of 83% and a recovery capacity of 97%. As shown by these results, the performance deterioration of the battery cells of Examples 1 and 2 was prevented.

According to aspects of the present invention, since a compound that forms a coordinate covalent bond with anions is included inside a case, the compound is coordinately combined with acid impurities consisting of anions in an electrolyte, preventing elution of the active material of an electrode. Accordingly, an electrode according to aspects of the present invention can be prevented from undergoing corrosion at a high voltage, accomplishing a high-capacity rechargeable lithium battery without an increased number of fabrication processes.

According to aspects of the present invention, since the compound may be included in a negative electrode, a positive electrode, or an electrolyte, it is relatively easy to produce a rechargeable lithium battery including an electrode in which corrosion is prevented.

In addition, since the compound may be coated inside the case, it can be easy to produce a rechargeable lithium battery including an electrode in which corrosion is prevented.

According to aspects of the present invention, since the compound includes an element of group 3B, 4B, 5A, or 5B, the compound can be coordinated with anions.

According to aspects of the present invention, since the compound may be selected from the group consisting of a phosphorus oxide, a boron oxide, and mixtures thereof, the compound can be easily coordinated with anions.

According to aspects of the present invention, since the compound may be P₂O₅ or B₂O₃, the compound can be easily coordinated with anions.

Aspects of the present invention provide a rechargeable lithium battery including an electrolyte including anions such as halogen ions and the like, that has a corrosion-resistant property.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A rechargeable lithium battery comprising:
a negative electrode;
a positive electrode;
an electrolyte; and
a case enclosing the negative electrode, the positive electrode and the electrolyte,
wherein the rechargeable lithium battery further comprises a compound that forms a coordinate covalent bond with anions in at least one of the negative electrode, the positive electrode, the electrolyte, and an inner surface of the case.

2. The rechargeable lithium battery of claim 1, wherein the compound comprises an element selected from the group consisting of Group 3B, Group 4B, Group 5A, and Group 5B elements, and combinations thereof.

3. The rechargeable lithium battery of claim 1, wherein the compound is selected from the group consisting of a phosphorus oxide, a boron oxide, and mixtures thereof.

4. The rechargeable lithium battery of claim 1, wherein the compound is P₂O₅ or B₂O₃.

5. The rechargeable lithium battery of claim 1, wherein at least one of the positive electrode and the negative electrode comprises a transition element.

6. The rechargeable lithium battery of claim 1, wherein the electrolyte comprises halogen ions.

7. A negative electrode of a rechargeable lithium battery, comprising:
a negative active material;
a conductive material;
a binder; and
a compound that forms a coordinate covalent bond with anions.

8. A positive electrode of a rechargeable lithium battery, comprising:
a positive active material;
a conductive material;
a binder; and
a compound that forms a coordinate covalent bond with anions.

9. An electrolyte of a rechargeable lithium battery, comprising
a lithium salt containing halogen ion impurities;
a solvent; and
a compound that forms a coordinate covalent bond with anions.

10. A case of a rechargeable lithium battery having an inner surface, wherein the inner surface of the case includes a coating comprising a compound that forms a coordinate covalent bond with anions.
